(19) United States
(12) Patent Application Publication
(10) Pub. No.: US 2025/0131440 A1
(43) Pub. Date: Apr. 24, 2025

(54) SYSTEMS AND METHODS TO DETECT FALSE FRAUD REPORTS

(71) Applicant: Capital One Services, LLC, McLean, VA (US)

(72) Inventors: Madeline RIESE, McLean, VA (US); Matthew KLOSTER, Falls Church, VA (US); Jeffrey RULE, Chevy Chase, MD (US)

(73) Assignee: Capital One Services, LLC, McLean, VA (US)

(21) Appl. No.: 18/918,443

(22) Filed: Oct. 17, 2024

Related U.S. Application Data
(60) Provisional application No. 63/544,965, filed on Oct. 20, 2023.

(51) Int. Cl. G06Q 20/40

(52) U.S. Cl. CPC G06Q 20/4016

(57) ABSTRACT

An exemplary method comprises receiving, by a processor, a user-based allegation of a fraudulent transaction, receiving, by the processor, merchant data pertaining to a user associated with the user-based allegation as well as a transaction underlying the user-based allegation, and receiving, by the processor, issuer data pertaining to the user and the transaction. The exemplary method further comprises applying, by the processor, a machine learning model to the merchant data and issuer data to generate a prediction as to whether the transaction was fraudulent, providing, by the processor, a report to the user comprising one or more factors on which the prediction is based, the one or more factors based on at least one of the merchant data and the issuer data, receiving, by the processor, feedback relating to the prediction, and updating, by the processor, the machine learning model using the feedback as an input.

### CROSS-REFERENCE TO RELATED APPLICATION

This application claims the priority of U.S. Provisional Patent Application No. 63/544,965, filed Oct. 20, 2023, the contents of which are incorporated herein by reference in their entirety.

### FIELD OF THE DISCLOSURE

The present disclosure relates to systems and methods for sharing data between a merchant and an issuer to detect and prevent false fraud.

### BACKGROUND

Credit card and transaction-based fraud is a common struggle facing consumers, merchants, and account issuers. One prevalent type of transaction-based fraud is false fraud where a card holder completes a legitimate transaction and then later claims the transaction was fraudulent. The card holder then has the benefit of the purchased goods or services and is refunded his or her money based on the fraud claim.

Systems and measures to combat transaction fraud have been instituted over the years. However, based on the nature and timing of false fraud, these systems often fail to address and/or prevent these types of claims. Current processes rely on chargeback pipeline through card networks which are independent of banks and/or other account issuers. Issuers generally pay card networks to conduct investigations and rely on decisions provided by the card network without further investigation. Further, issuers and/or banks often forego any investigation because the process requires individualized transaction inquiries which can be time and resource intensive. As a result, many card issuers and/or banks will not institute a false fraud investigation when the transaction amount is below a certain threshold, instead opting to simply refund the transaction amount to the card holder as a matter of pragmatism. The threshold for instituting an investigation can be quite high, sometimes reaching $400 or more per claim, which creates opportunities for false fraud at amounts lower than the threshold.

Even if card issuers and/or banks wanted to implement more robust false fraud prevention methods and systems, they have very limited information on which to make a false fraud determination. Of course, when trying to determine false fraud, having access to information about the transaction is key. However, issuers only have very limited information about a pending transaction, such as date, transaction amount, merchant, card details, etc. It would be beneficial to have additional information about the transaction and the consumer in order to make a more accurate and efficient false fraud prediction.

These and other deficiencies exist. Accordingly, there is a need for creating issuer access to additional relevant transaction data, especially from merchants in order to facilitate false fraud predictions.

### SUMMARY OF THE DISCLOSURE

In some aspects, the techniques described herein relate to a method for collaborative false fraud prevention, the method including the steps of: receiving, by a processor, a user-based allegation of a fraudulent transaction; receiving, by the processor, merchant data pertaining to a user associated with the user-based allegation as well as a transaction underlying the user-based allegation; receiving, by the processor, issuer data pertaining to the user and the transaction; applying, by the processor, a machine learning model to the merchant data and issuer data to generate a prediction as to whether the transaction was fraudulent; providing, by the processor, a report to the user including one or more factors on which the prediction is based, the one or more factors based on at least one of the merchant data and the issuer data; receiving, by the processor, feedback relating to the prediction; and updating, by the processor, the machine learning model using the feedback as an input.

In some aspects, the techniques described herein relate to a method, further including providing, by the processor, an option for the user to retract the user-based allegation of a fraudulent transaction.

In some aspects, the techniques described herein relate to a method, wherein the feedback on the prediction includes a user response to the option for the user to retract the user-based allegation of a fraudulent transaction.

In some aspects, the techniques described herein relate to a method, further including receiving, by the processor, mobile device data for a mobile device associated with the user.

In some aspects, the techniques described herein relate to a method, wherein the merchant data includes mobile device data for a mobile device associated with the user.

In some aspects, the techniques described herein relate to a method, further including receiving, by the processor, third party metrics data pertaining to the user.

In some aspects, the techniques described herein relate to a method, wherein the user-based allegation of a fraudulent transaction is approved or denied based on the prediction as to whether the transaction was fraudulent.

In some aspects, the techniques described herein relate to a method, further including receiving, by the processor via a communication hub, supplemental user data from a plurality of issuers or a plurality of banks.

In some aspects, the techniques described herein relate to a method, further including sending, via the processor, the prediction as to whether the transaction was fraudulent to the communication hub.

In some aspects, the techniques described herein relate to a system for collaborative fraud prevention, the system including: a memory storing issuer data for a user; and a processor, wherein the processor is configured to: receive a user-based allegation of a fraudulent transaction, receive merchant data pertaining to a user associated with the user-based allegation as well as a transaction underlying the user-based allegation, receive issuer data pertaining to the user and the transaction, apply a machine learning model to the merchant data and issuer data to generate a prediction as to whether the transaction was fraudulent, provide a report to the user including one or more factors on which the prediction is based, the one or more factors based on at least one of the merchant data and the issuer data, receive feedback relating to the prediction, and update the machine learning model using the feedback as an input.

In some aspects, the techniques described herein relate to a system, wherein the processor is further configured to receive mobile device data for a mobile device associated with the user.

In some aspects, the techniques described herein relate to a system, wherein the mobile device data includes a plurality of an internet protocol address, a geo-location, and a unique device identifier (ID).

In some aspects, the techniques described herein relate to a system, wherein the merchant data includes a plurality of a user name, a user phone number, a user email address, a user physical address, a list of historical merchant transactions, a frequency of merchant purchases, an account age for a merchant account associated with the user, a total number of items, recurring order information, shipping information, and a merchant risk score.

In some aspects, the techniques described herein relate to a system, wherein the merchant data includes the mobile device data.

In some aspects, the techniques described herein relate to a system, wherein the user-based allegation of a fraudulent transaction is approved or denied based on the prediction as to whether the transaction was fraudulent.

In some aspects, the techniques described herein relate to a system, wherein the processor is further configured to provide an option for the user to retract the user-based allegation of a fraudulent transaction.

In some aspects, the techniques described herein relate to a system, wherein the feedback on the prediction includes a user response to the option for the user to retract the user-based allegation of a fraudulent transaction.

In some aspects, the techniques described herein relate to a system, wherein the processor is further configured to receive, via a communication hub, supplemental user data from a plurality of issuers or a plurality of banks.

In some aspects, the techniques described herein relate to a system, wherein the processor is further configured to send the prediction as to whether the transaction was fraudulent to the communication hub.

In some aspects, the techniques described herein relate to a computer-readable non-transitory medium including computer-executable instructions that, when executed by a processor, cause the processor to perform procedures including the steps of: receiving a user-based allegation of a fraudulent transaction; receiving merchant data pertaining to a user associated with the user-based allegation as well as a transaction underlying the user-based allegation; receiving issuer data pertaining to the user and the transaction; applying a machine learning model to the merchant data and issuer data to generate a prediction as to whether the transaction was fraudulent; providing a report to the user including one or more factors on which the prediction is based, the one or more factors based on at least one of the merchant data and the issuer data; receiving feedback relating to the prediction; and updating the machine learning model using the feedback as an input.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Various embodiments of the present disclosure, together with further objects and advantages, may best be understood by reference to the following description taken in conjunction with the accompanying drawings.

FIG. 1 illustrates a system for sharing data between a merchant and an issuer to facilitate prediction and prevention of false fraud claims according to an exemplary embodiment.

FIG. 2 illustrates a sequence of operations for sharing user data after receipt of a fraud claim to detect false fraud according to an exemplary embodiment.

FIG. 3 illustrates a sequence of operations for sharing user data after receipt of a fraud claim to detect false fraud according to an exemplary embodiment.

FIGS. 4A and 4B illustrate a system for using a central processor to share data between merchants and issuers to detect and prevent false fraud according to an exemplary embodiment.

FIG. 5 is a schematic representation of an issuer backend according to an exemplary embodiment.

FIG. 6 is a schematic representation of a machine learning algorithm module within the issuer backend according to an exemplary embodiment.

### DETAILED DESCRIPTION

The following description of embodiments provides non-limiting representative examples referencing numerals to particularly describe features and teachings of different aspects of the invention. The embodiments described will be recognized as capable of implementation separately, or in combination, with other embodiments from the description of the embodiments and the features and teachings of any embodiment can be interchangeably combined with the features and teachings of any other embodiment. A person of ordinary skill in the art reviewing the description of embodiments will be able to learn and understand the different described aspects of the invention. The description of embodiments will facilitate understanding of the invention to such an extent that other implementations, not specifically covered but within the knowledge of a person of skill in the art having read the description of embodiments, will be understood to be consistent with an application of the invention.

Furthermore, the described features, advantages, and characteristics of the embodiments may be combined in any suitable manner. A person of ordinary skill in the art will recognize that the embodiments may be practiced without one or more of the specific features or advantages of an embodiment. In other instances, additional features and advantages may be recognized in certain embodiments that may not be present in all embodiments. A person of ordinary skill in the art will understand that the described features, advantages, and characteristics of any embodiment can be interchangeably combined with the features, advantages, and characteristics of any other embodiment.

The present invention provides systems and methods by which issuers may investigate and predict instances of false fraud in user-attempted chargebacks (e.g., fraudulent transaction notifications). Currently there is no efficient, thorough, cost effective, and real-time way for issuers to receive and process fraudulent transaction notifications from card holders. As discussed, issuers and/or banks currently rely on card networks to perform investigations that are costly, slow, and predicated on limited information. Issuers and/or banks pay for these services, so investigations are generally only instituted when an accused transaction amount exceeds a certain threshold, which can eclipse many hundreds of dollars or more. Issuers and merchants are uniquely situated to collect a plethora of relevant data that can help inform the legitimacy of a fraud notification, but merchants and issuers do not historically share (or even collect) these types of information. Financial incentives to merchants and issuers from reduced instances of false fraud chargebacks provide incentive to collect and share data between merchants and issuers for this purpose.

The present invention creates systems and methods for merchants to collect and share relevant transaction and user-based data with issuers, thereby allowing for more accurate fraud and false fraud predicting. The present discloses systems and methods for not only collecting and sharing this information, but also using it to predict outcomes and rationales that are then shared with card holders. Card holders may then be provided opportunities to respond to rationales and criteria relied upon to reach a certain prediction. The feedback may be used to correct mistakes or otherwise confirm correct predictions. In all instances, the feedback may be used to improve the predictions and computers used for those predictions.

Further, the present invention employs a machine learning algorithm to analyze and relate the merchant data with issuer data, as well as any other data available to an issuer. The machine learning algorithm predicts the likelihood of false fraud based on all of the available data and also may provide the rationale for the prediction. Use of a machine learning algorithm to predict false fraud may reduce demands on traditional card networks. Additionally, the machine learning algorithm may promote system efficiency by reducing the demands on backend systems over time to improve the functioning of computers and conserve system resources when dealing with large volumes of transaction data.

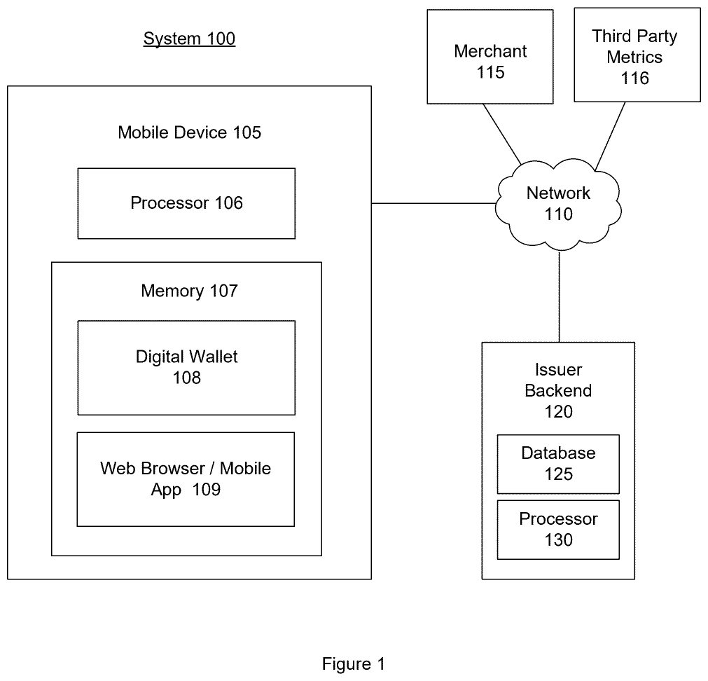

FIG. 1 illustrates a system 100 for using merchant and other data shared with an issuer/bank to make false fraud determinations after a reported fraudulent transaction. The system 100 may include a mobile device 105, a network 110, an issuer backend 120, a merchant 115, and third party metrics 116. Although FIG. 1 illustrates single instances of components of system 100, system 100 may include any number of components.

System 100 may include a mobile device 105. The mobile device 105 may include one or more processors 106, e.g., one or more microprocessors, and memory 107, e.g., random access memory (RAM) and/or read only memory (ROM). Memory 107 may include one or more applications, such as web browser and/or mobile app 109 as well as digital wallet 108. Web browser and/or mobile app 109 may be capable of displaying a merchant webpage. The mobile device 105 may be in data communication with any number of components of system 100. For example, the mobile device 105 may transmit data via network 110 to merchant 115, which may comprise of browsing a merchant website and/or completing purchase transactions from merchant 115. Merchant 115 may be any consumer-based entity and the merchant website may be any website that facilitates transactions for goods and/or services. Such merchant website may run on any sufficient computing device such as a network-enabled computer, server, etc. each with one or more processors configured to host, display, resolve, and otherwise cause the merchant website to be available to remote computing devices such as mobile device 105. Merchant 115 may also include memory coupled to the processors and which may store user information. Mobile device 105 may also transmit data via network 110 to processor 130 and/or database 125 of issuer backend 120. Without limitation, the mobile device 105 may be a network-enabled computer and may have a credit card, smart card, or the like associated with the device directly or through a digital wallet 108. As referred to herein, a network-enabled computer may include, but is not limited to a computer device, or communications device including, e.g., a server, a network appliance, a personal computer, a workstation, a phone, a handheld PC, a personal digital assistant, a contactless card, a thin client, a fat client, an Internet browser, a kiosk, a tablet, a terminal, an ATM, or other device. The device 105 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The mobile device 105 may include processing circuitry and may contain additional components, including processors, memories, error and parity/CRC checkers, data encoders, anticollision algorithms, controllers, command decoders, security primitives and tamper-proofing hardware, as necessary to perform the functions described herein. The mobile device 105 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touchscreen, keyboard, mouse, cursor-control device, touchscreen, microphone, digital camera, video recorder or camcorder. These devices may be used to enter information and interact with the software and other devices described herein.

System 100 may include a network 110. In some examples, network 110 may be one or more of a wireless networks, a wired network or any combination of wireless network and wired network, and may be configured to connect to any one of components of system 100. For example, the mobile device 105 may be configured to connect to issuer backend 120 via network 110. In some examples, network 110 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, near field communication (NFC), Radio Frequency Identification (RFID), Wi-Fi, and/or the like.

In addition, network 110 may include, without limitation, telephone lines, fiber optics, IEEE Ethernet 902.3, a wide area network, a wireless personal area network, a LAN, or a global network such as the Internet. In addition, network 110 may support an Internet network, a wireless communication network, a cellular network, or the like, or any combination thereof. Network 110 may further include one network, or any number of the exemplary types of networks mentioned above, operating as a stand-alone network or in cooperation with each other. Network 110 may utilize one or more protocols of one or more network elements to which they are communicatively coupled. Network 110 may translate to or from other protocols to one or more protocols of network devices. Although network 110 is depicted as a single network, it should be appreciated that according to one or more examples, network 110 may comprise a plurality of interconnected networks, such as, for example, the Internet, a service provider's network, a cable television network, corporate networks, such as credit card association networks, and home networks.

System 100 may include issuer backend 120 which may comprise one or more servers or other computing devices. In some examples, the one or more servers may include one or more processors, represented as processor 130 and coupled to memory, represented as database 125. The server(s) may be configured as a central system, server or platform to control and call various data at different times to execute a plurality of workflow actions.

In some examples, the server(s) can be a dedicated server computer, such as bladed servers, or can be personal computers, laptop computers, notebook computers, palm top computers, network computers, mobile devices, wearable devices, or any processor-controlled device capable of supporting the system 100. While FIG. 1 illustrates a single server, it is understood that other embodiments can use multiple servers or multiple computer systems as necessary or desired to support the users and can also use back-up or redundant servers to prevent network downtime in the event of a failure of a particular server.

The server may include an application in memory comprising instructions for execution thereon. For example, the application may comprise instructions for execution on the server. The application may be in communication with any components of system 100. For example, the server may execute one or more applications that enable, for example, network and/or data communications with one or more components of system 100, transmit and/or receive data, and perform the functions described herein. Without limitation, the server may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a contactless card, a thin client, a fat client, an Internet browser, or other device. The server also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server may include processing circuitry and may contain additional components, including processors (e.g., one or more micropocessors), memories, error and parity/CRC checkers, data encoders, anticollision algorithms, controllers, command decoders, security primitives and tamper-proofing hardware, as necessary to perform the functions described herein. The server may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touchscreen, keyboard, mouse, cursor-control device, touchscreen, microphone, digital camera, video recorder or camcorder. These devices may be used to enter information and interact with the software and other devices described herein.

System 100 may include one or more third-party metrics 116. Third party metrics 116 may include any third-party that provides or otherwise makes available data and statistics regarding potential fraud as it relates to a multitude of users. Third party metrics 116 may comprise one or more servers or other computing devices. In some examples, the one or more servers may include one or more processors and may be coupled to memory. The server(s) may be configured as a central system, server or platform to control and call various data at different times to execute a plurality of workflow actions. In some examples, the server(s) can be a dedicated server computer, such as bladed servers, or can be personal computers, laptop computers, notebook computers, palm top computers, and/or network computers capable of supporting the system 100. The memory may store information and data relevant to users, merchants, issuers and/or banks that are relevant to potential fraud and false fraud.

System 100 may include one or more databases 125. The database 125 may comprise a relational database, a non-relational database, or other database implementations, and any combination thereof, including a plurality of relational databases and non-relational databases. In some examples, the database 125 may comprise a desktop database, a mobile database, or an in-memory database. Further, the database 125 may be hosted internally by any component of system 100 or the database 125 may be hosted externally to any component of the system 100 by a cloud-based platform, or in any storage device that is in data communication with the mobile device 105 and issuer backend 120. In some examples, database 125 may be in data communication with any number of components of system 100. For example, the processor 106 in data communication with the digital wallet 108 may be configured to transmit one or more requests for the requested data from database 125 via network 110.

In some examples, exemplary procedures in accordance with the present disclosure described herein can be performed by a processing arrangement and/or a computing arrangement (e.g., computer hardware arrangement). Such processing and/or computing arrangement can be, for example entirely or a part of, or include, but not limited to, a computer and/or processor that can include, for example one or more microprocessors, and use instructions stored on a computer-accessible medium (e.g., RAM, ROM, hard drive, or other storage device). For example, a computer-accessible medium can be part of the memory of the mobile device 105, issuer backend 120, and/or database 125, or other computer hardware arrangement.

In some examples, a computer-accessible medium (e.g., as described herein above, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

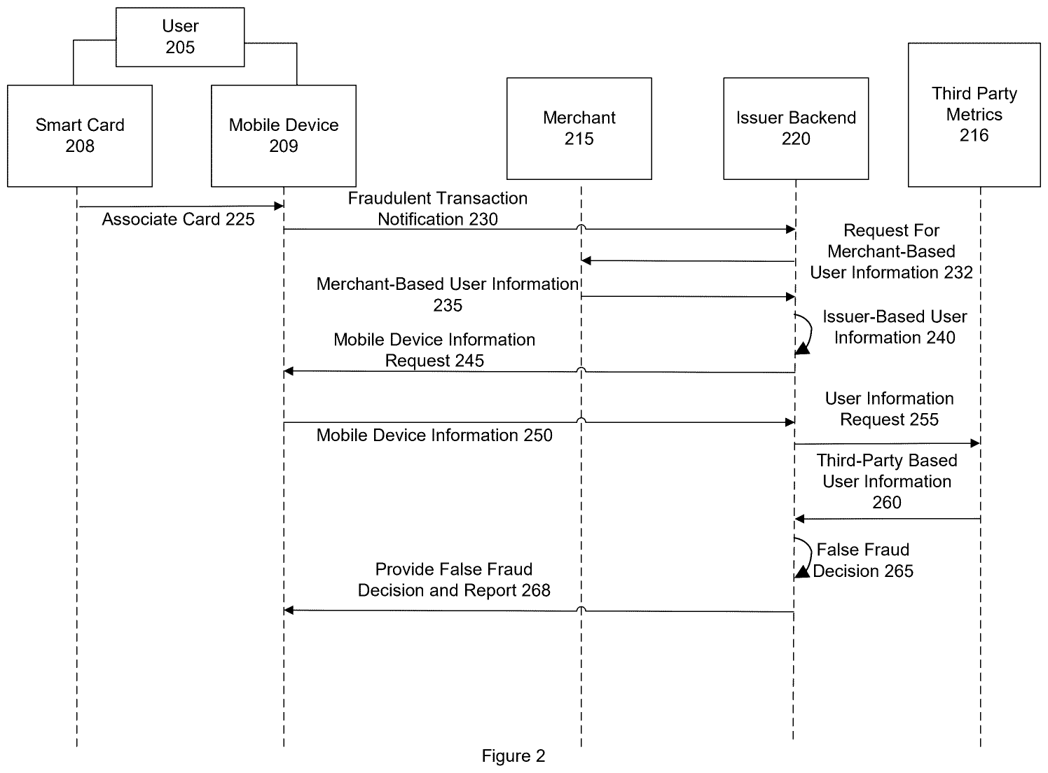

The sequence diagram of FIG. 2 illustrates an exemplary application of embodiments of the invention in conjunction with the system 100 of FIG. 1. In the scenario set forth in FIG. 2, a user 205 has a smart card 208 and a mobile device 209. The mobile device 209 can be in communication with a merchant 215 for the purpose of conducting purchase transactions, and in communication with an issuer backend 220 for the purpose of reporting fraud. Mobile device 209 may be a personal computer, smart phone, smart watch, or any other network enabled computing device. Mobile device 209 may include memory, a network communication, an interactive user interface, and a processor capable of running one or more software applications and a digital wallet. Smart card 208 may be any chip enabled credit card or the like. Smart card 208 may be in communication with mobile device 209 via Bluetooth, NFC, or any other suitable short range communication protocol.

Issuer backend 220 may include one or more processors and may be in communication with mobile device 209, merchant 215, and third party metrics 216. Issuer backend 220 may be configured to transmit to and receive data from merchant 215 pertaining to a purchase transaction relating to a fraud notification, and may be configured to transmit to and receive data from third party metrics 216.

Merchant 215 may include one or more processors and memory, as well as storage. It may be configured to run one or more websites, apps, etc. It may be further configured to provide a consumer facing sales interface that enables consumer purchase transactions of one or more goods or services on a website or app associated with merchant 215. It may be configured to communicate with backend 220 in order to transmit user data, including transaction data, relating to one or more transactions that are the subject of a fraud notification.

Third party metrics 216 may include one or more processors and storage, such as a database or databases. It may be configured to receive data requests from issuer backend 220 and respond by providing data responsive to those requests.

User 205 may hold smart card 208 that may be associated with an issuer as well as one or more financial and/or credit accounts, etc. with that issuer. User 205 may also have a mobile device 209. At 225, User 205 may associate smart card 208 with mobile device 209 through any means available. By way of non-limiting example, this may be through inclusion of smart card 208 in a digital wallet of mobile device 209. It may also be through inclusion of smart card 208 with an application installed and running on mobile device 209. The application may be a shopping application or some other application that allows or facilitates payment of online purchases. Smart card 208 may be associated with mobile device 209 through any technological means, including but not limited to, manual entry, NFC, Bluetooth, etc. The association of smart card 208 may permit and/or enable mobile device 209 to collect and/or store information pertaining to user 205 as well as the user's account(s) associated with smart card 208.

At step 230, mobile device 209 may transmit a fraudulent transaction notification to issuer backend 220. User 205 may have noticed an unauthorized transaction on his or her account. This may manifest through monthly statements, through a digital wallet associated with mobile device 209, etc. The fraudulent transaction notification of step 230 may include filling out an online form, sending an email, sending a text, making a phone call, or any other means of alerting an issuer of potential fraud.

Issuer backend 220 may, in turn, send a request to merchant 215 for merchant-based user information at step 232. For example, if the alleged fraudulent transaction of step 230 was conducted at merchant ABC, then the request for merchant-based user information will be sent to merchant ABC (who would be merchant 215 in this example). The request for merchant-based user information may include the particulars of the fraud notification, such as a transaction ID, transaction date, transaction amount, user name, and/or any other information that helps merchant 215 identify the relevant user and accused transaction(s).

Merchant 215 may, as a result of receiving the request for merchant-based user information at step 232, provide merchant-based user information to issuer backend 220 at step 235. In order to provide the merchant-based user information, merchant 215 may collect data relevant to the accused transaction. For example, merchant 215 may capture the specifics of any and/or all transactions. The specifics may include the number of products, price of products, highest priced item, descriptions of products, time of transaction request, name of user 205, shipping method, phone number, email address, address of user 205, shipping address of user 205, as well as any additional information provided by user 205 in connection with the relevant transaction(s). In some instances, this information may also include video/audio recordings of the transaction at a physical checkout, if applicable.

Merchant 215 may also include a memory, such as one or more databases, that stores data relevant to user 205. For instance, merchant 215 may store, and have access to, not only data related to the accused transaction, but also data pertaining to user 205's purchase history, including items and/or services purchased, dates of purchase, transaction amounts, transaction frequency, item purchase repetition, changes in user 205 purchase behavior, history and frequency of gift card use, information as to whether the accused transaction is part of a recurring order, age of any user account with merchant 215, velocity metrics (e.g. how often are transactions being requested by user 205 over a given period of time), merchant trust scores for user 205, etc.

Merchant 215 may also collect data from mobile device 209. This data may include one or more internet protocol (IP) addresses, geo-location, one or more unique identifiers (IDs) assigned to the device, etc.

Merchant 215 may package this information and send it to issuer backend 220 in real-time as the transaction request is pending. Historically, merchant 215 does not share any data pertaining to user 205 with an issuer except that data required to process a form of payment offered by user 205. However, given that merchants may sometimes be left responsible for fraudulent charges, those merchants may be incentivized to work with issuers/banks in order to reduce instances of fraud, including false fraud claims.

The merchant-based user information shared with issuer backend 220 at step 235 may be transmitted off network rails. For example, the merchant-based user information may be sent separate from a credit card network transmission. As noted, traditional approaches rely on card networks to run investigations and reach conclusions as to fraud claims by card holders (e.g., users). Exemplary systems and methods disclosed herein represent a fundamental change to traditional processes in that issuers/banks may take on the role of investigating and rendering determinations as to user-based fraud claims. In some embodiments, the transmission of merchant-based user information may occur in parallel to traditional credit card network transmission seeking to authorize a transaction request.

At step 240, issuer backend 220 may collect issuer-based user information. This data may exist on one or more databases associated with the issuer and in connection with issuer backend 220. The issuer-based user information may include data that the issuer has been able to collect about user 205. For example, issuer-based user information may include user transaction history, not just with merchant 215, but for all purchases made by user 205 with smart card 208 or mobile device 209 (used as proxy for smart card 208 through a digital wallet or the like). This data may also include transaction history for one or more other different accounts held by user 205 with the issuer. The data may not include visibility as to specific items that were purchased, individual pricing of items, etc. as part of the accused transaction or any other transaction, but this data may provide transaction amounts including largest transactions over a given time frame, largest transactions at each discrete merchant, merchant transaction frequency, dates, velocity metrics, purchase patterns, purchase locations, etc. For example, issuer-based user information may highlight that user 205 has never used smart card 208 at merchant 215 prior to the accused transaction. Or, this data could reveal that smart card 208 has only ever been used with a single merchant and that merchant is not merchant 215. The information may further reveal that while user 205 has never used smart card 208 with merchant 215, that user has used a different card with merchant 215 on a regular basis. These are relevant pieces of information for issuer backend 220. Another example of relevant issuer-based user information might be a revelation that a large percentage of user purchases occur within a geographic space defined by some measurement. If the accused transaction of fraud notification at step 230 originates from a large distance away from that defined geographic location, then this fact could implicate potential fraud. However, if the user's most recent transaction history indicates that user 205 may have travelled to the location where the accused transaction originates, then that information could potentially weigh in favor of a false fraud determination.

At step 245, issuer backend 220 may request mobile device information from mobile device 209. At step 250, mobile device 209 may return the respond to the request. The response may include one or more pieces of mobile device data. This data may include one or more internet protocol (IP) addresses, geo-location, one or more unique ID's assigned to the device, etc. This request may be in addition to the device information included in the merchant-based user information sent at step 235. This information may be useful to compare against mobile device data collected by merchant 215 contemporaneous with the accused transaction. For example, if the accused transaction was conducted online, then merchant 215 may have collected device information such as IP address, geo location, etc. Mobile device information received at step 250 may also include a device IP address, geo location, etc. If the geo location of mobile device 209 at step 250 is the same as at the time of the accused transaction, then this weighs in favor of a false fraud determination. The same is true if the respective IP addresses match up, there are identical device identifiers, or any other matching data points that tend to suggest that mobile device 209 was used in connection with the accused transaction.

In some embodiments, a digital wallet where smart card 208 is associated with mobile device 209 may have one or more pieces of software that automatically collect device data for mobile device 209. In some embodiments, the collected device data may be sent automatically to issuer backend 220 as a result of the accused transaction. In this instance, issuer backend 220 may already have the relevant device information that was collected contemporaneously with the accused transaction, and then only needs to compare with the mobile device information provided at step 250.

In some embodiments, issuer backend 220 may request user information from third party metrics 216 at step 255. This request may be triggered by receipt of the fraudulent transaction notification of step 230 and/or the subsequent merchant-based information shared at step 235. The user information request of step 255 may pertain specifically to user 205. The request may also pertain to merchant 215, and in some embodiments, may include both. Third party metrics 216 may include any third-party that provides or otherwise makes available data and statistics regarding potential fraud. Third party metrics 216 may create and store relevant data including one or more fraud model scores pertaining to user 205, merchant 215, and/or both. This data may also include bot detection, phone ownership checks from third-party providers, confirmation of mobile device data, etc. At step 260, the third-party metrics may be returned to issuer backend 220.

At step 265, issuer backend 220, may parse and/or integrate all of the relevant information. Issuer backend may follow one or more rules, decision trees, strategies, etc. for applying the integrated data that includes the merchant-based user information. As a result of this process, issuer backend 220 may reach a false fraud decision based on application of the rules to the dataset. The false fraud decision may allow or disallow the transaction request. This false fraud decision may occur independently from any investigation conducted by the card network and in parallel to that investigation. In some embodiments, false fraud decision at step 265 may override an decision from an investigation conducted by a card network. In other exemplary embodiments, the false fraud decision of step 265 may be in place of any investigation that might be run by a card network. Further, collection, parsing, integrating, any applying of the user information/data, as well as the transaction decision of step 265 may occur in real-time after the fraudulent transaction notification at step 230. Accordingly, in some embodiments, a false fraud decision of step 265 may be rendered effectively instantaneously with the fraud notification, as opposed to traditional card network investigations which may take weeks or even months to resolve.

At step 268, user 205 may be provided the false fraud decision of step 265 via mobile device 209. In the event that the decision finds actual fraud, there may simply be an indication that fraud was confirmed as well as an indication of a credit to the account for the fraudulent charge amount. Additionally, an actual credit to user 205's account may be processed at step 268. However, in the event that the false fraud decision finds false fraud, user 205 may be informed that the notification is deemed fraudulent. This notification may be less severe given that it is in effect a determination that user 205 is lying. Thus, at step 268, the message to user 205 may be less accusatory. For example, the message may indicate that the issuer/bank was unable to confirm the accused transaction as fraudulent, and therefore the transaction will not be refunded. The communication with user 205 may leave open the possibility that the issuer/bank is incorrect. For example, issuer backend 220 may provide a mechanism for user 205 to provide additional evidence and/or support that issuer backend 220 may consider and reevaluate its decision based on this additional information. The mechanism may be an invitation to provide a response, a link to provide additional information, a phone number to call, etc.

In the event that issuer backend 220 determines an instance of false fraud, user 205 may not only be informed of this decision but may also be provided rationale for this decision. That rationale may be provided in the form of a report. The report may detail any number of factors on which the decision was made. These factors may be provided in any order including in an order ranging from the most important or definitive factors down to the least important factors. The report may provide only the most important factor, or any number of relevant factors. The report may include all factors that reach above a certain relevance threshold. For example, if the decision at step 265 includes any sort of factor weighting based on perceived importance to the decision, then the report may include all factors above a certain relevance based on factor weighting. In some exemplary embodiments, the report of step 268 may include one or more links for reply. For example, the report may include a single link where user 205 may go to dispute the decision and/or provide additional evidence and/or relevant information. In some embodiments, the report may include links after one or more of the factors/rationales provided as to why the decision was reached. Each link may provide additional information regarding that specific factor/rationale. Each such link may also provide a path for user 205 to provide additional/new evidence or information regarding that specific factor/rationale.

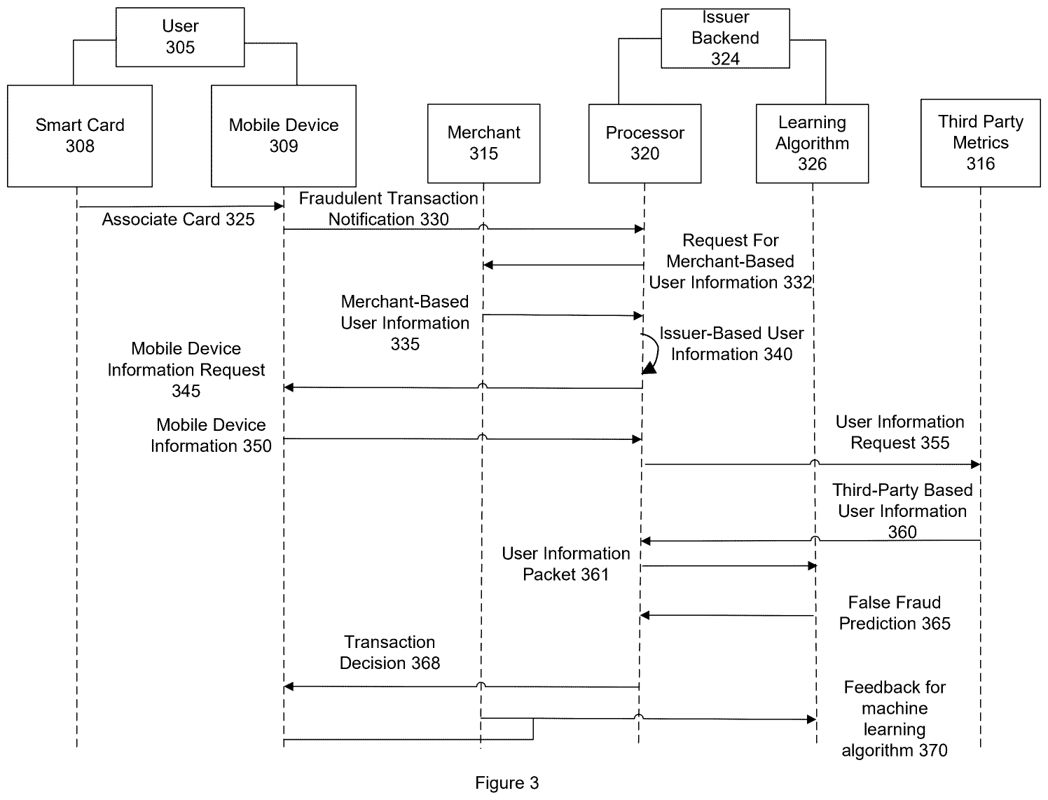

The sequence diagram of FIG. 3 illustrates an exemplary application of embodiments of the invention in conjunction with the system 100 of FIG. 1. In the scenario set forth in FIG. 3, a user 305 has a smart card 308 and a mobile device 309. The mobile device 309 can be in communication with a merchant 315 for the purpose of conducting purchase transactions, and in communication with a processor 320 for the purpose of reporting fraud. Mobile device 309 may be a personal computer, smart phone, smart watch, or any other network enabled computing device. Mobile device 309 may include memory, a network communication, an interactive user interface, and a processor capable of running one or more software applications and a digital wallet. Smart card 308 may be any chip enabled credit card or the like. Smart card 308 may be in communication with mobile device 309 via Bluetooth, NFC, or any other suitable short range communication protocol.

Issuer backend 324 may include one or more processors and may be in communication with mobile device 309, merchant 315, and third party metrics 316. Processor 320 may be configured to transmit to and receive data from merchant 315 pertaining to a purchase transaction relating to a fraud notification and may be configured to transmit to and receive data from third party metrics 316.

Merchant 315 may include one or more processors and memory, as well as storage. It may be configured to run one or more websites, apps, etc. It may be further configured to provide a consumer facing sales interface that enables consumer purchase transactions of one or more goods or services on a website or app associated with merchant 315. It may be configured to communicate with issuer backend 324 via processor 320 in order to transmit user data, including transaction data, relating to one or more transactions that are the subject of a fraud notification.

Third party metrics 316 may include one or more processors and storage, such as a database or databases. It may be configured to receive data requests from processor 320 and respond by providing data responsive to those requests.

User 305 may hold smart card 308 that may be associated with an issuer as well as one or more financial and/or credit accounts, etc. with that issuer. User 305 may also have a mobile device 309. At step 325, user 305 may associate smart card 308 with mobile device 309 through any means available. By way of non-limiting example, this may be through inclusion of smart card 308 in a digital wallet of mobile device 309. It may also be through inclusion of smart card 308 with an application installed and running on mobile device 309. The application may be a shopping application or some other application that allows or facilitates payment of online purchases. Smart card 308 may be associated with mobile device 309 through any technological means, including but not limited to, manual entry, NFC, Bluetooth, etc. The association of smart card 308 may permit and/or enable mobile device 309 to collect and/or store information pertaining to user 305 as well as the user's account(s) associated with smart card 308.

At step 330, mobile device 309 may transmit a fraudulent transaction notification to processor 320. User 305 may have noticed an unauthorized transaction on his or her account. This may manifest through monthly statements, through a digital wallet associated with mobile device 309, etc. The fraudulent transaction notification of step 330 may include filling out an online form, sending an email, sending a text, making a phone call, or any other means of alerting an issuer of potential fraud. In some exemplary embodiments, the fraudulent transaction notification may not be a formal fraud notification or transaction dispute, but rather may be an inquiry to regarding a suspected or unrecognized transaction.

Processor 320 may, in turn, send a request to merchant 315 for merchant-based user information at step 332. For example, if the alleged fraudulent transaction of step 230 was conducted at merchant ABC, then the request for merchant-based user information will be sent to merchant ABC (who would be merchant 315 in this example). The request for merchant-based user information may include the particulars of the fraud notification, such as a transaction ID, transaction date, transaction amount, user name, and/or any other information that helps merchant 315 identify the relevant user and accused transaction(s).

Merchant 315 may, as a result of receiving the request for merchant-based user information at step 332, provide merchant-based user information to processor 320 at step 335. In order to provide the merchant-based user information, merchant 315 may collect data relevant to the accused transaction. For example, merchant 315 may capture the specifics of any and/or all transactions. The specifics may include the number of products, price of products, highest priced item, descriptions of products, time of transaction request, name of user 305, shipping method, phone number, email address, address of user 305, shipping address of user 305, as well as any additional information provided by user 305 in connection with the relevant transaction(s). In some instances, this information may also include video/audio recordings of the transaction at a physical checkout, if applicable.

Merchant 315 may also include a memory, such as one or more databases, that stores data relevant to user 305. For instance, merchant 315 may store, and have access to, not only data related to the accused transaction, but also data pertaining to user 305's purchase history, including items and/or services purchased, dates of purchase, transaction amounts, transaction frequency, item purchase repetition, changes in user 305 purchase behavior, history and frequency of gift card use, information as to whether the accused transaction is part of a recurring order, age of any user account with merchant 315, velocity metrics (e.g. how often are transactions being requested by user 305 over a given period of time), merchant trust scores for user 305, etc.

Merchant 315 may also collect data from mobile device 309. This data may include one or more internet protocol (IP) addresses, geo-location, one or more IDs assigned to the device, etc.

Merchant 315 may package this information and send it to processor 320 in real-time as the transaction request is pending. Historically, merchant 315 does not share any data pertaining to user 305 with an issuer except that data required to process a form of payment offered by user 305. However, given that merchants may sometimes be left responsible for fraudulent charges, those merchants may be incentivized to work with issuers/banks in order to reduce instances of fraud, including false fraud claims.

The merchant-based user information shared with processor 320 at step 335 may be transmitted off network rails. For example, the merchant-based user information may be sent separate from a credit card network transmission. As noted, traditional approaches rely on card networks to run investigations and reach conclusions as to fraud claims by card holders (e.g., users). Exemplary systems and methods disclosed herein represent a fundamental change to traditional processes in that issuers/banks may take on the role of investigating and rendering determinations as to user-based fraud claims. In some embodiments, the transmission of merchant-based user information may occur in parallel to traditional credit card network transmission seeking to authorize a transaction request.

At step 340, processor 320 may collect issuer-based user information. This data may exist on one or more databases associated with the issuer and in connection with issuer backend 324. The issuer-based user information may include data that the issuer has been able to collect about user 305. For example, issuer-based user information may include user transaction history, not just with merchant 315, but for all purchases made by user 305 with smart card 308 or mobile device 309 (used as proxy for smart card 308 through a digital wallet or the like). This data may also include transaction history for one or more other different accounts held by user 305 with the issuer. The data may not include visibility as to specific items that were purchased, individual pricing of items, etc. as part of the accused transaction or any other transaction, but this data may provide transaction amounts including largest transactions over a given time frame, largest transactions at each discrete merchant, merchant transaction frequency, dates, velocity metrics, purchase patterns, purchase locations, etc. For example, issuer-based user information may highlight that user 305 has never used smart card 308 at merchant 315 prior to the accused transaction. Or, this data could reveal that smart card 308 has only ever been used with a single merchant and that merchant is not merchant 315. The information may further reveal that while user 305 has never used smart card 308 with merchant 315, that user has used a different card with merchant 315 on a regular basis. These are relevant pieces of information for processor 320. Another example of relevant issuer-based user information might be a revelation that a large percentage of user purchases occur within a geographic space defined by some measurement. If the accused transaction of fraud notification at step 330 originates from a large distance away from that defined geographic location, then this fact could implicate potential fraud. However, if the user's most recent transaction history indicates that user 305 may have travelled to the location where the accused transaction originates, then that information could potentially weigh in favor of a false fraud determination.

At step 345, processor 320 may request mobile device information from mobile device 309. At step 350, mobile device 309 may return the respond to the request. The response may include one or more pieces of mobile device data. This data may include one or more internet protocol (IP) addresses, geo-location, one or more unique ID's assigned to the device, etc. This request may be in addition to the device information included in the merchant-based user information sent at step 335. This information may be useful to compare against mobile device data collected by merchant 315 contemporaneous with the accused transaction. For example, if the accused transaction was conducted online, then merchant 315 may have collected device information such as IP address, geo location, etc. Mobile device information received at step 350 may also include a device IP address, geo location, etc. If the geo location of mobile device 309 at step 350 is the same as at the time of the accused transaction, then this weighs in favor of a false fraud determination. The same is true if the respective IP addresses match up, there are identical device identifiers, or any other matching data points that tend to suggest that mobile device 309 was used in connection with the accused transaction.

In some embodiments, a digital wallet where smart card 308 is associated with mobile device 309 may have one or more pieces of software that automatically collect device data for mobile device 309. In some embodiments, the collected device data may be sent automatically to processor 320 as a result of the accused transaction. In this instance, processor 320 may already have the relevant device information that was collected contemporaneously with the accused transaction, and then only needs to compare with the mobile device information provided at step 350.

In some embodiments, processor 320 may request user information from third party metrics 316 at step 355. This request may be triggered by receipt of the fraudulent transaction notification of step 330 and/or the subsequent merchant-based information shared at step 335. The user information request of step 355 may pertain specifically to user 305. The request may also pertain to merchant 315, and in some embodiments, may include both. Third party metrics 316 may include any third-party that provides or otherwise makes available data and statistics regarding potential fraud. Third party metrics 316 may create and store relevant data including one or more fraud model scores pertaining to user 305, merchant 315, and/or both. This data may also include bot detection, phone ownership checks from third-party providers, confirmation of mobile device data, etc. At step 360, the third-party metrics may be returned to processor 320.

At step 361, the data collected by processor 320 may be packaged and sent to learning algorithm 326 for analysis. Learning algorithm 326 may consider any and all of the data from merchant 315, issuer backend 324, as well as third party metrics 316. In making a likelihood of false fraud determination, learning algorithm 326 may consider the data in relation to the accused transaction (e.g., the potential loss given the transaction amount), the amount of data, the relevance of the data, relationships between metrics, between metrics and the transaction request, etc. The learning algorithm 326 may provide weights to each metric/data point and make predictions based on a complex analysis of all metrics, relative deviation(s) in each metric, connections between metrics as determined by deep learning aspects of learning algorithm 326, summing or subtracting deviations based on relationships with other metrics, increasing or decreasing relative weights based on established relationships between and among metrics, etc. The learning algorithm 326 may also adjust weighting and relationships based on feedback from previous false fraud predictions. Learning algorithm 326 may be able to test detected relationships and analyses based on these relationships through feedback on predictions over time. In some embodiments, there may be a hybrid approach where some number of baseline rules are programmed and then learning algorithm 326 operates and makes predictions on top of that baseline set of rules. The baseline set of rules may include boundary rules when the learning algorithm 326 must, or must not, conclude the existence of false fraud. These baseline rules may also include factors that the algorithm may not consider and/or correlate to other factors in its prediction. These rules may be dictated by law or otherwise be an attempt to eliminate potential bias and/or hallucinations from learning algorithm 326.

Learning algorithm 326 may be an open artificial intelligence (AI) system. This requirement may be necessary so that the reason and logic behind false fraud predictions are known and understood, and may subsequently be included in reports to users. This information may be necessary to correct any potential deviations learning algorithm may attempt to make based on irrelevant details or details that may otherwise not be allowed under law. Moreover, the reasons for a fraud prediction may be necessary to form the basis for feedback into the learning algorithm and/or to otherwise provide notice to user 305. For instance, a fraud notification for a transaction may be refused based on a false fraud prediction from learning algorithm 326. In such an instance, the user is deprived of a monetary recovery while maybe preventing false fraud. There must be a way to determine whether such refusals are accurate or if they are overinclusive false positives. Determining the accuracy of a prediction in this context may be greatly aided by an understanding of the basis for each outcome and/or prediction.

To the extent that a prediction may be simplified to one or more primary factors (as opposed to a complex interaction of factors), it is also important to be able to provide that information to user 305. For instance, if a false fraud prediction is rendered and a report is sent to user 305, it would be beneficial to say in that report that not only was there a suspected false fraudulent situation, but that the false fraud is suspected because it the transaction originated from the same location as user 305, was in connection with a merchant 315 that user 305 regularly purchases from, and for a product that user 305 buys on a regular basis. This provides user 305 with the basis for the false fraud refusal which, if incorrect, provides user 305 with the information required to resolve the discrepancies with the issuer. Not only does this facilitate commerce, it also provides critical feedback for learning algorithm 326.

The fraud prediction may not be a simple yes/no prediction, instead, there may be finer gradations within the predictions. For example, learning algorithm 326 may determine some degree of elevated likelihood of false fraud. In some embodiments, the false fraud prediction may be a score on a predetermined scale. When learning algorithm 326 provides the false fraud prediction to processor 320 at step 365, processor 320 may further process the prediction to reach a transaction decision. The transaction decision may be based on a likelihood of fraud predicted by learning algorithm 326 and may be transmitted to user 305 via mobile device 309. The false fraud decision may confirm fraud or otherwise allege false fraud. This false fraud decision may occur independently from any investigation conducted by the card network and in parallel to that investigation. In some embodiments, false fraud prediction of step 365 may override a decision from an investigation conducted by a card network. In other exemplary embodiments, the false fraud prediction of step 365 may be in place of any investigation that might be run by a card network. Further, collection, parsing, integrating, any applying of the user information/data, as well as the transaction prediction of step 365 may occur in real-time after the fraudulent transaction notification at step 330. Accordingly, in some embodiments, a false fraud prediction of step 365 may be rendered effectively instantaneously with the fraud notification, as opposed to traditional card network investigations which may take weeks or even months to resolve.

At step 368, user 305 may be provided the false fraud decision via mobile device 309. The notification may be sent to mobile device 309 and may entail a text, phone call, email, in-app message, or any other form of digital communication. The message may be tailored depending on the delivery medium. For instance, if processor 320 sends a text message to mobile device 309, the text may simply tell user 305 the result of the fraud investigation for the accused transaction involving the account of smart card 308. The text may also include a phone number link that when clicked, initiates a call to the issuer. The text may also include a clickable link to other relevant pieces of information. For example, there may be links in the text to the user's account, transaction details relevant to the fraud notification, location information, etc. In the event that an accused transaction request originates from a brick and mortar store for merchant 315, and that merchant has shared video surveillance data, the link may include video showing the attempted transaction. This may allow user 305 to recognize the person attempting the transaction. An email alert may include some, all, or none of the same links possible in the text message or in-app message options. In some exemplary embodiments where the fraud notification is simply an inquiry as to an unrecognized charge/transaction, the report and false fraud decision may be on an informational basis and provide data that can help the user to remember the validity of questioned transaction/charge, thereby preventing a formal fraud notification (e.g., charge dispute). In such instance, a user may be prompted whether they wish to proceed with a fraudulent charge process in light of the provided information (e.g., report and/or determination). The notice may be via a link, pop-up box, etc. Similarly, even if a user has initiated a fraud chargeback process (as opposed to an inquiry or the like), the notification may provide the user with the ability to stop or otherwise retract the chargeback process in light of the notification and/or the report provided by issuer backend 324, as discussed below.

In the event that the decision finds actual fraud, there may simply be an indication that fraud was confirmed as well as an indication of a credit to the account for the fraudulent charge amount (e.g., a chargeback approval). Additionally, an actual credit to user 305's account may be processed at step 368. However, in the event that the false fraud decision finds false fraud, user 305 may be informed that the notification is deemed fraudulent. This notification may be less severe given that it is in effect a determination that user 305 is lying. Thus, at step 368, the message to user 305 may be less accusatory. For example, the message may indicate that the issuer/bank was unable to confirm the accused transaction as fraudulent, and therefore the transaction will not be refunded. The communication with user 305 may leave open the possibility that the issuer/bank is incorrect. For example, processor 320 may provide a mechanism for user 305 to provide additional evidence and/or support that processor 320 may consider and reevaluate its decision based on this additional information. The mechanism may be an invitation to provide a response, a link to provide additional information, a phone number to call, etc.

In the event that processor 320 determines an instance of false fraud, user 305 may not only be informed of this decision but may also be provided rationale for this decision. That rationale may be provided in the form of a report. The report may detail any number of factors on which the decision was made. These factors may be provided in any order including in an order ranging from the most important or definitive factors down to the least important factors. The report may provide only the most important factor, or any number of relevant factors. The report may include all factors that reach above a certain relevance threshold. For example, if the false fraud decision includes any sort of factor weighting based on perceived importance to the decision, then the report may include all factors above a certain relevance based on factor weighting. In some exemplary embodiments, the report of step 368 may include one or more links for reply. For example, the report may include a single link where user 305 may go to dispute the decision and/or provide additional evidence and/or relevant information. In some embodiments, the report may include links after one or more of the factors/rationales provided as to why the decision was reached. Each link may provide additional information regarding that specific factor/rationale. Each such link may also provide a path for user 305 to provide additional/new evidence or information regarding that specific factor/rationale

In some exemplary embodiments, instead of simply denying a fraud claim and/or accusing user 305 of false fraud, processor 320 may provide a report to user 305 detailing the relevant factors as to why false fraud is likely and provide an opportunity for user 305 to withdraw the fraud notification in light of the relevant information.

Triggering a response from user 305 is one form of feedback for learning algorithm 326 at step 370. Additionally, feedback may come from merchant 315. The feedback is provided to learning algorithm 326 to train, further refine, and improve learning algorithm 326. The user feedback data may help train the machine learning algorithm in a variety of different ways. For example, if the user feedback is indicates an incorrect prediction, for example, a user response explaining/evidencing how the accused transaction is fraudulent, then the learning algorithm 326 will be able to refine its predictions and change and/or optimize weighting and relationships that led to the incorrect prediction. The same may be true for feedback indicating that learning algorithm 326 correctly predicted false fraud. This feedback may be useful to more positively reinforce correct predictions, or to make refinements in the case where learning algorithm 326 may have made the correct prediction, but for faulty reasons. This may include changing weighting for factors that more strongly favor the correct analysis, etc. The foregoing are examples of how the user feedback data may be used by the learning algorithm 326 and are not meant to be exhaustive.

With continued feedback and training of the learning algorithm 326 over time, the learning algorithm 326 may not only become more accurate, but also more efficient. This is because less computing resources are required as the machine learning algorithm becomes more confident in its predictions. Thus, not only is the accuracy of the predictions improved over time, but the functioning of the computer is also improved over time as the learning algorithm 326 is trained.

The predictions discussed with respect to FIG. 3 may be conducted regardless of the amount of an accused transaction. While traditional card network investigations are not initiated for amounts below a threshold, often $400 or higher, the predictions discussed here may occur in real time or near real time and regardless of the transaction amount.

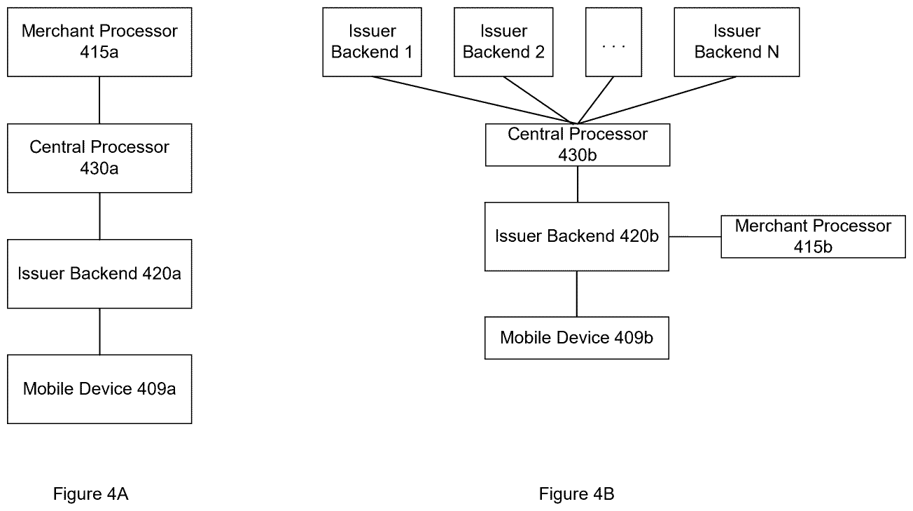

FIG. 4A describes an embodiment of exemplary systems. This exemplary system is similar to that depicted in FIG. 1 in that all of the elements depicted are network enabled, however FIG. 4A focuses on the chain of and/or digital communication/information sharing between an issuer backend and a mobile device as well as a merchant processor. Another difference as compared with FIG. 1 is the inclusion of central processor 430a. The central processor 430a is connected to an issuer backend 420a and merchant processor 415a, and stands between issuer backend 420a and merchant processor 415a in the digital communication chain. An issuer backend can include a processor or server associated with a provider of personal financing, including without limitation checking accounts, savings accounts, credit accounts, or some combination thereof. For example, an issuer backend can include the credit card provider associated with a user's credit card.

In this embodiment, the process is similar to that described in FIG. 2 except that central processor 430a sits between merchant processor 415a and issuer backend 420a. Mobile device 409a belonging to a user may still be used to initiate a fraud notification with issuer backend 420a. In turn, issuer backend 420a may collect issuer-based user information. This information may include details regarding the transaction that is allegedly fraudulent such as transaction date, time, merchant, amount, etc. The issuer-based user information may also include historical transaction data for the user. For example, the historical data may include instance of prior purchases at the relevant merchant, amounts of those relevant purchases, dates and times of those purchases, location(s), and/or any historical data that helps determine one or more user purchasing patterns.

Issuer backend 420a may also seek to obtain merchant-based user data. Merchant processor 415a may collect user data including data relevant to both the transaction request as well as historical user data available to merchant processor 415a. Instead of issuer backend 420a directly requesting the merchant-based user information and merchant processor 415a sharing this merchant-based user data directly with issuer backend 420a, the request and returned data move through central processor 430a as an intermediary. Thus, central processor 430a receives a request from issuer backend 420a and forwards that request to merchant processor 415a. Likewise, central processor 430a receives the requested data from merchant processor 415a and then makes the merchant-based user information available to issuer backend 420a. The central processor may store the merchant-based user information and serve as a storage and clearinghouse for merchant-based user information.

In some embodiments, central processor 430a may directly receive the fraud notice from mobile device 409a directly and then route the notice to issuer backend 420a. In some embodiments, central processor 430a make an initial determination as to the potential for false fraud. For example, if there are one or more obvious false fraud indicators, central processor 430a may predict false fraud and deny the transaction immediately and/or provide a report to the mobile device 409a explaining the basis for such a conclusion. In other embodiments, central processor 430a may be equipped to perform the false fraud predictions made by the issuer backend described with respect to FIGS. 2 and 3.

In some embodiments, multiple issuer backends may connect to central processor 430a as well as multiple merchants. Central processor 430a may be able to not only store the data from various merchants, it may be able to direct the data to the correct issuer backend. Also, central processor 430a may be able to access and share relevant merchant-based user information across different discrete user fraud notifications and/or with different issuer backends. For example, if a user initiates a fraud notification with issuer backend 420a via mobile device 409a, then central processor 430a may not only provide the merchant-based user information from merchant processor 415a with issuer backend 420a, but may also search its own storage and find merchant-based user data from other merchants relating to the same user and/or mobile device 409a. Central processor 430a may send this additional information to issuer backend 420a. Similarly, in future user fraud notifications, the merchant-based user data that was created by merchant processor 415a in the example above may be used by central processor 430a to supplement the information share relating to the future user fraud notification either with issuer backend 420a or with a different issuer backend.

Not only is central processor 430a capable of increasing the relevant data shared with issuer backend 420a (as well as with other issuer backends), it may also be capable of receiving issuer-based user information from issuer backend 420a. Central processor 430a may be capable of storing this data and further supplementing relevant data share with any of the communicating issuer backends. For example, issuer backend 420a may provide to central processor 430a, issuer-based user data pertaining to a user associated with a user fraud notification. Central processor 430a may store that issuer-based user information. In a subsequent transaction request involving a different issuer backend, central processor 430a may include the stored issuer-based user information with the merchant-based user information that it sends to that different issuer backend. Thus, the different issuer backend has more historical user transaction data than it otherwise would have and can make a more informed decision/prediction regarding the likelihood that the user fraud notification is an instance of false fraud. Thus, the central processor 430a may form the hub in an information sharing architecture where each issuer backend, and each merchant, creates a spoke off of the hub.

In some embodiments, the sharing of issuer data between issuers may not happen automatically or be dictated by the central processor 430a. In some embodiments, an issuer may request supplemental issuer backend from other issuers as part of creating a false fraud prediction. The request may be sent to the central processor 430a and routed to one or more of the participating issuers. The issuers may then respond to the request through the central processor 430a.

In the embodiment illustrated in FIG. 4B, the architecture of the hub and spoke system is slightly different. Here, a user fraud notification may be received by issuer backend 420b from a user via mobile device 409b. As a result, issuer backend 420b may directly request merchant-based user information from merchant processor 415b, and the merchant-based user information may be directly shared with issuer backend 420b, similar to FIG. 2. In turn, issuer backend 420b may send the merchant-based user information, as well as the issuer-based user information to central processor 430b. Central processor 430b may be connected to any number of issuer backends 1 through N.

The central processor 430b may store the issuer-based user information as well as the merchant-based user information shared by issuer backend 420b. Central processor 430b may serve as a storage and clearinghouse for issuer-based user information and merchant-based user information. Central processor 430b may be able to access and share relevant merchant-based user information across different discrete user fraud notifications and/or with different issuer backends. For example, if a user initiates a fraud notification with issuer backend 420b via mobile device 409b, then central processor 430b, upon issuer backend 420b sharing relevant data with central processor 430b, may search its own storage and find merchant-based user data from other merchants relating to the same user and/or mobile device 409b. Central processor 430b may return this additional information to issuer backend 420b. Similarly, in future fraud notifications, the merchant-based user data that was created by merchant processor 415b in the example above may be used by central processor 430b to supplement the information share relating to the future transaction request either with issuer backend 420b or with a different issuer backend, such as issuer backend 1 through N. The same is true for sharing issuer-based user data among the various issuer backends. Central processor 430a may be capable of storing this issuer-based user data and further supplementing relevant data share with any of the communicating issuer backends. For example, issuer backend 420b may provide to central processor 430b, issuer-based user data pertaining to a user associated with a fraud notification. Central processor 430a may store that issuer-based user information. In a subsequent fraud notification involving a different issuer backend, central processor 430b may include the stored issuer-based user information with the merchant-based user information that it sends to that different issuer backend (1 through N). As a result, the different issuer backend has more historical user transaction data than it otherwise would have, and can make a more informed decision/prediction regarding the likelihood that the pending transaction request is an instance of false fraud. Thus, the central processor 430b may form the hub in an information sharing architecture where each issuer backend creates a spoke off of the hub.

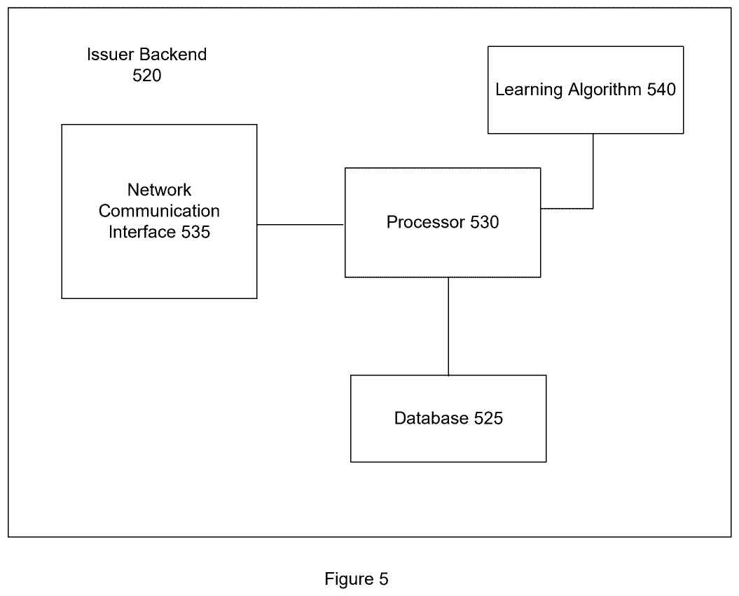

With reference to FIG. 5, issuer backend 520 may be a server such as a dedicated server computer, such as bladed servers, or personal computer, laptop computer, notebook computer, palm top computer, network computer, or any processor-controlled device capable of supporting the system 100. While FIG. 5 illustrates an issuer backend 520 that may be a single server, it is understood that other embodiments can use multiple servers or multiple computer systems as necessary or desired to support the users and can also use back-up or redundant servers to prevent network downtime in the event of a failure of a particular server. In a particular embodiment illustrated in FIG. 5, issuer backend 520 includes a processor 530 in communication with a database 525, a network communication interface 535, and a learning algorithm 540. The processor 530 may include a microprocessor and associated processing circuitry, and can contain additional components, including processors, memories, error and parity/CRC checkers, data encoders, anticollision algorithms, controllers, command decoders, security primitives and tamper-proofing hardware, as necessary to perform the functions described herein. The database 525 may comprise memory and can be a read-only memory, write-once read-multiple memory or read/write memory, e.g., RAM, ROM and EEPROM, and the user device can include one or more of these memories.

The network communication interface 535 is configured to establish and support wired and/or wireless data communication capability for connecting the issuer backend 520 to the network 110 or other communication network. The network communication interface 535 can also be configured to support communication with a short-range wireless communication interface, such as Bluetooth.

In embodiments of the invention, the processor 530 may be in communication, through network communication interface 535, with a user's mobile device to receive fraud notifications and to provide false fraud determinations and reports. Processor 530 may also be in communication with a merchant in order to monitor and collect user-based merchant data, triggered by user fraud notifications. Processor 530 may also be in communication, through network communication interface 535, with a third-party metrics aggregator in order to request/receive third-party user data. Processor 530 may store this user-based data in database 525. Additionally, processor 530 may access issuer-based user data from database 525. Processor 530 may send this user-based data, as well as fraud notification details to learning algorithm 540 for use in predicting instances of false fraud in connection with the accused transaction(s). Learning algorithm 540 may use the provided data/information, as well as additional inputs to predict a likelihood that the fraud notification is an instance of false fraud by the user. Processor 530 may receive the false fraud prediction and incorporate it into a fraud decision that it may pass on to the user in conjunction with a report.

The fraud decision may confirm or reject the user's fraud notification. This decision may be in conjunction with, or in place of, a card network's traditional fraud investigation process. This fraud decision may occur independently from the card network authorization process and in parallel to that process. Further, the transaction decision may occur in real-time or near real-time as measured from when the user submits the fraud notification. In some embodiments, the fraud decision may override a fraud decision from a card authorization network.

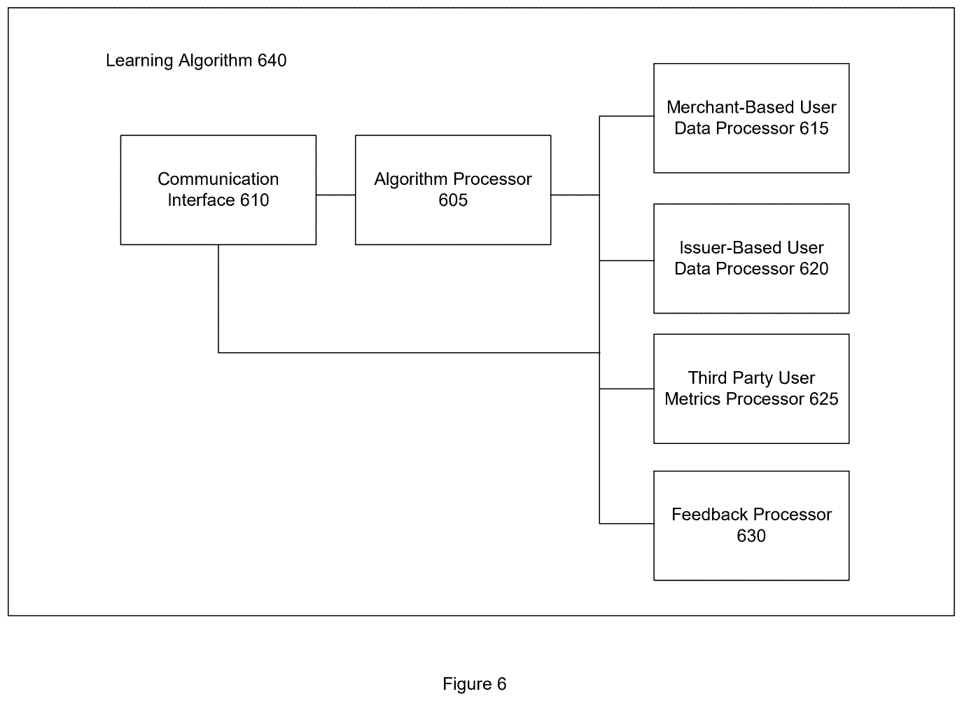

With reference to FIG. 6, learning algorithm 640 may be part of issuer backend 520 and may predict the likelihood that an accused transaction is fraudulent or is a case of false fraud. Learning algorithm 640 may be “open” so that services providers and/or issuers can see the logic behind false fraud predictions. The reasoning or logic behind predictions made by learning algorithm 640 may be important so that these reasons may be conveyed in some instances to users for feedback or continuing the fraud investigation process. In other instances, the logic applied by learning algorithm 640 may need to be specifically altered if it is a criteria deemed irrelevant, unlawful, biased, etc. by a bank or issuer. Learning algorithm 640 may include a communication interface 610 as well as an algorithm processor 605 coupled to a plurality of additional processors including merchant-based user data processor 615, issuer-based user data processor 620, third party metrics processor 625, and feedback processor 630. The processors of FIG. 6 may include microprocessors and associated processing circuitry, and can contain additional components, including processors, memories, error and parity/CRC checkers, data encoders, anticollision algorithms, controllers, command decoders, security primitives and tamper-proofing hardware, as necessary to perform the functions described herein. It should be appreciated that while FIG. 6 depicts multiple discrete processors, the machine learning algorithm may be accomplished by any number of processors including a single processor.

Learning algorithm 640 may receive a number of inputs from the issuer backend through communication interface 610. These inputs may include merchant-based user data, which may include data relevant to an accused transaction. For example, a merchant may capture specifics pertaining to the accused transaction(s) including number of products, price of products, total transaction cost, highest priced item, descriptions of products, time of transaction request, name of the user who requested the transaction(s), requested shipping method, user phone number, user email address, user address, a shipping address, as well as any additional information provided by a user in connection with a transaction request. A merchant may also provide relevant historical user data vis-à-vis the merchant. For instance, a merchant may store, and have access to, data pertaining to a user's purchase history with the merchant, including items and/or services purchased, dates of purchase, transaction amounts, transaction frequency, item purchase repetition, changes in user purchase behavior, when and how often a gift card is used as part of the transaction, if the transaction request is a periodically recurring order, age of any user account with the merchant, velocity metrics (e.g. how often are transactions being requested by user over a given period of time), merchant trust scores for the user, etc. A merchant may also collect and then share data from a user's mobile device that was used in the relevant transaction(s). This data may include one or more internet protocol (IP) addresses, geo-location, one or more unique ID's assigned to the device, etc. This merchant-based user data may be provided as an input to merchant-based user data processor 615.

Another learning algorithm 640 input may include issuer-based user data. This data may include information that the issuer has been able to collect about a user over time. For example, issuer-based user information may include user transaction history, not just with a specific merchant, but for all purchases made by the user with a smart card or mobile device linked to an account for the issuer. This data may also include transaction history for one or more other different accounts held by the user with the issuer. The data may not include visibility as to specific items that were purchased, individual pricing of items, etc., but this data may provide transaction amounts including largest transactions over a given time frame, largest transactions at each discrete merchant, merchant transaction frequency, dates, velocity metrics, purchase patterns, purchase locations, etc. For example, issuer-based user information may highlight that a user has never used a given smart card or account at a specific merchant prior to an accused transaction. Or, this data could reveal that the smart card/account has only ever been used with a single merchant and that merchant is not the merchant in the accused transaction. The information may further reveal, for example, that while the user has never used the smart card/account with the merchant in the accused transaction, that user has used a different card/account with the relevant merchant on a regular basis. These are relevant (example) pieces of information for the issuer-based user data processor 620. Another example of relevant issuer-based user information might be a revelation that a large percentage of a user's purchases occur within a geographic space defined by some measurement or boundary. If an accused transaction originated from a long distance away from that defined geographic location, then this fact could implicate a legitimate fraud. However, if the user's most recent transaction history indicates that the user may have travelled to the location where transaction request originated, then that information would seem to weigh in favor of an instance of a false fraud claim.

Learning algorithm 640 may also receive third-party user-based metrics. Third party user-based metrics may include data relating to one or more fraud model scores pertaining to a user, a merchant, and/or both. This data may also include online bot detection (based on navigation speed, navigation patterns, skipping interfaces, failure to satisfy bot detection protocols, etc.), phone ownership checks from third-party providers, confirmation of mobile device data, etc.

Additionally, learning algorithm 640 may receive feedback as a discrete type of input. The feedback may include feedback from a user and in some instances a merchant, relating to one or more false fraud predictions and/or decisions (e.g., refusal to refund money for the accused transaction) as well as user notifications and explanations thereof. The accuracy of a learning algorithm 640 prediction may be inferred from the feedback and updated/edited accordingly.

Learning algorithm 640 may consider any and all of the inputs from processors 615, 620, 625, and 630, as well as the data input into those processors. In making a likelihood of false fraud prediction, learning algorithm 640 may consider the data in relation to the accused transaction (e.g., the potential loss given the requested transaction amount), the amount of data, the relevance of the data, relationships between metrics, between metrics and the transaction request, etc. The learning algorithm 640 may assign weights to each metric/data point and make predictions based on a complex analysis of all metrics, relative deviation(s) in each metric, connections/relationships between metrics as determined by deep learning aspects of learning algorithm 640, summing or subtracting deviations based on relationships with other metrics, increasing or decreasing relative weights based on established relationships between and among metrics, etc. The learning algorithm 640 may also adjust weighting and relationships based on feedback from previous false fraud predictions. Learning algorithm 640 may be able to test detected relationships and analyses based on these relationships through feedback on predictions over time. In some embodiments, there may be a hybrid approach where some number of baseline rules are programmed and then learning algorithm 640 operates and makes predictions on top of that baseline set of rules. The baseline set of rules may include boundary rules when the learning algorithm 640 must, or must not, conclude the existence of false fraud.

Learning algorithm 640 may be an open AI system. This requirement may be necessary so that the reason and logic behind false fraud predictions is known and understood. This information may be necessary to correct any potential deviations learning algorithm may attempt to make based on irrelevant details, details that may otherwise not be allowed to be considered under law, details that may represent system bias, details that may cause system hallucinations, etc. Moreover, the reasons for a fraud prediction may be necessary to form the basis for feedback into the learning algorithm and/or to otherwise provide reports to users. For instance, a fraud notification may be denied or otherwise challenged based on a false fraud prediction from learning algorithm 640. In such an instance, the challenge/denial will have prevented a user from recovering money associated with the accused transaction(s) while potentially preventing actual fraud. There may be a way to determine whether such denials/challenges are accurate or if they are over-inclusive, false positives of the existence of false fraud. Determining the accuracy of a prediction in this context may be greatly aided by an understanding of the basis for the outcome/prediction. To the extent that a prediction may be simplified to one or more primary factors (as opposed to a complex interaction of factors), it is also important to be able to provide that information to the user. For instance, if a fraud notification is denied/challenged and a report sent to the user, it would be beneficial to include in that report that not only is false fraud suspected, but that the false fraud is suspected because the accused transaction originated from the same geographic location as the user's phone is currently located, that the user routinely purchases the same goods from the same merchant, etc. This provides the user with the basis for the denial/challenge which, if incorrect, further provides the user with the information required to resolve the problem with the issuer/bank. For example, if a phone number link is provided in a communication message with the user, that user may contact the issuer and alert them that he or she lives in an apartment complex and that the user suspects a neighbor stole the user's account information, which could account for the similarity in the geographic location between the device used in the accused transaction and the user's current device location. Not only does this facilitate commerce, it also provides critical feedback for learning algorithm 640 at feedback processor 630. Moreover, the false fraud prediction may not be a simple yes/no prediction, instead, there may be finer gradations within the predictions. For example, learning algorithm 640 may determine some degree of elevated likelihood of false fraud. The granularity of potential false fraud in a prediction may be as fine as necessary to maximize the accuracy of the system and may become more granular as the system improves with feedback over time.

Feedback processor 630 may help refine future predictions by further analyzing the correct and incorrect prediction feedback. It may be the case that a prediction was correct but based on faulty reasoning/logic. In that case, the feedback is useful to train the learning algorithm by changing assumptions, weighting, revisiting perceived relationships, etc. In the event that the algorithm predicted correctly, and the prediction was based on a correct analysis, the feedback processor 630 may use the feedback to further reinforce the correct analysis. This may include changing weighting for factors that more strongly favor the correct analysis, etc.

The learning algorithms may comprise predictive models and as described herein can utilize a Bidirectional Encoder Representations from Transformers (BERT) models. BERT models utilize use multiple layers of so called “attention mechanisms” to process textual data and make predictions. These attention mechanisms effectively allow the BERT model to learn and assign more importance to words from the text input that are more important in making whatever inference is trying to be made.

The predictive models described herein can utilize a Bidirectional Encoder Representations from Transformers (BERT) models. BERT models utilize use multiple layers of so called “attention mechanisms” to process textual data and make predictions. These attention mechanisms effectively allow the BERT model to learn and assign more importance to words from the text input that are more important in making whatever inference is trying to be made.

The predictive models described herein may utilize various neural networks, such as convolutional neural networks (“CNNs”) or recurrent neural networks (“RNNs”), to generate the exemplary models. A CNN may include one or more convolutional layers (e.g., often with a subsampling step) and then followed by one or more fully connected layers as in a standard multilayer neural network. CNNs may utilize local connections and may have tied weights followed by some form of pooling which may result in translation invariant features.

A RNN is a class of artificial neural network where connections between nodes form a directed graph along a sequence. This facilitates the determination of temporal dynamic behavior for a time sequence. Unlike feedforward neural networks, RNNs may use their internal state (e.g., memory) to process sequences of inputs. A RNN may generally refer to two broad classes of networks with a similar general structure, where one is finite impulse and the other is infinite impulse. Both classes of networks exhibit temporal dynamic behavior. A finite impulse recurrent network may be, or may include, a directed acyclic graph that may be unrolled and replaced with a strictly feedforward neural network, while an infinite impulse recurrent network may be, or may include, a directed cyclic graph that may not be unrolled. Both finite impulse and infinite impulse recurrent networks may have additional stored state, and the storage may be under the direct control of the neural network. The storage may also be replaced by another network or graph, which may incorporate time delays or may have feedback loops. Such controlled states may be referred to as gated state or gated memory, and may be part of long short-term memory networks (“LSTMs”) and gated recurrent units.

RNNs may be similar to a network of neuron-like nodes organized into successive “layers,” each node in a given layer being connected with a directed e.g., (one-way) connection to every other node in the next successive layer. Each node (e.g., neuron) may have a time-varying real-valued activation. Each connection (e.g., synapse) may have a modifiable real-valued weight. Nodes may either be (i) input nodes (e.g., receiving data from outside the network), (ii) output nodes (e.g., yielding results), or (iii) hidden nodes (e.g., that may modify the data en route from input to output). RNNs may accept an input vector x and give an output vector y. However, the output vectors are based not only by the input just provided in, but also on the entire history of inputs that have been provided in in the past.

For supervised learning in discrete time settings, sequences of real-valued input vectors may arrive at the input nodes, one vector at a time. At any given time step, each non-input unit may compute its current activation (e.g., result) as a nonlinear function of the weighted sum of the activations of all units that connect to it. Supervisor-given target activations may be supplied for some output units at certain time steps. For example, if the input sequence is a speech signal corresponding to a spoken digit, the final target output at the end of the sequence may be a label classifying the digit. In reinforcement learning settings, no teacher provides target signals. Instead, a fitness function, or reward function, may be used to evaluate the RNNs performance, which may influence its input stream through output units connected to actuators that may affect the environment. Each sequence may produce an error as the sum of the deviations of all target signals from the corresponding activations computed by the network. For a training set of numerous sequences, the total error may be the sum of the errors of all individual sequences.

The models described herein may be trained on one or more training datasets, each of which may comprise one or more types of data. In some examples, the training datasets may comprise previously-collected data, such as data collected from previous uses of the same type of systems described herein and data collected from different types of systems. In other examples, the training datasets may comprise continuously-collected data based on the current operation of the instant system and continuously-collected data from the operation of other systems. In some examples, the training dataset may include anticipated data, such as the anticipated future workloads, currently scheduled workloads, and planned future workloads, for the instant system and/or other systems. In other examples, the training datasets can include previous predictions for the instant system and other types of system and may further include results data indicative of the accuracy of the previous predictions. In accordance with these examples, the predictive models described herein may be training prior to use and the training may continue with updated data sets that reflect additional information.

As used herein, the term “issuer” is not limited to a particular account-issuing entity and/or card-issuing entity. Rather, it is understood that the present disclosure includes any type of account-issuing entity, including commercial entities (e.g., banks, merchants, professional service organizations, technology companies), industrial entities (e.g., builders, manufacturers), social entities (e.g., clubs, member-only organizations), and government entities (e.g., federal government, state government, local government).

As used herein, the term “bank” is not limited to a particular bank or type of bank. Rather, it is understood that the present disclosure includes any type of bank or other business involved in activities where products or services are sold or otherwise provided.

As used herein, the term “merchant” is not limited to a particular merchant or type of merchant. Rather, it is understood that the present disclosure includes any type of merchant, vendor, or other entity involved in activities where products or services are sold or otherwise provided.

As used herein, the term “account” is not limited to a particular type of account. Rather, it is understood that the term “account” can refer to a variety of accounts, including without limitation, a financial account (e.g., a credit account, a debit account), a membership account, a loyalty account, a subscription account, a services account, a utilities account, a transportation account, and a physical access account. It is further understood that the present disclosure is not limited to accounts issued by a particular entity.

As used herein, the term “card” is not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, membership cards, transportation cards, access cards), to cards associated with a particular type of account (e.g., a credit account, a debit account, a membership account), or to cards issued by a particular entity (e.g., a commercial entity, a financial institution, a government entity, a social club). Instead, it is understood that the present disclosure includes cards having any purpose, account association, or issuing entity.

It is noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, and any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, e.g., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

As described above, the various embodiments of the present invention support a number of communication devices and components, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, e.g., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, JavaScript and/or Python. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of “user interfaces” may be utilized to allow a user to interface with the mobile devices or other personal computing device. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

We claim:

1. A method for false fraud prevention, the method comprising the steps of:
receiving, by a processor, a user-based allegation of a fraudulent transaction;
receiving, by the processor, merchant data pertaining to a user associated with the user-based allegation as well as a transaction underlying the user-based allegation;
receiving, by the processor, issuer data pertaining to the user and the transaction;
applying, by the processor, a machine learning model to the merchant data and issuer data to generate a prediction as to whether the transaction was fraudulent;
providing, by the processor, a report to the user comprising one or more factors on which the prediction is based, the one or more factors based on at least one of the merchant data and the issuer data;
receiving, by the processor, feedback relating to the prediction; and
updating, by the processor, the machine learning model using the feedback as an input.

2. The method of claim 1, further comprising providing, by the processor, an option for the user to retract the user-based allegation of a fraudulent transaction.

3. The method of claim 2, wherein the feedback on the prediction comprises a user response to the option for the user to retract the user-based allegation of a fraudulent transaction.

4. The method of claim 1, further comprising receiving, by the processor, mobile device data for a mobile device associated with the user.

5. The method of claim 1, wherein the merchant data includes mobile device data for a mobile device associated with the user.

6. The method of claim 1, further comprising receiving, by the processor, third party metrics data pertaining to the user.

7. The method of claim 1, wherein the user-based allegation of a fraudulent transaction is approved or denied based on the prediction as to whether the transaction was fraudulent.

8. The method of claim 1, further comprising receiving, by the processor via a communication hub, supplemental user data from a plurality of issuers or a plurality of banks.

9. The method of claim 8, further comprising sending, via the processor, the prediction as to whether the transaction was fraudulent to the communication hub.

10. A system for false fraud prevention, the system comprising:
a memory storing issuer data for a user; and
a processor,
wherein the processor configured to:
receive a user-based allegation of a fraudulent transaction,
receive merchant data pertaining to a user associated with the user-based allegation as well as a transaction underlying the user-based allegation,
receive issuer data pertaining to the user and the transaction,
apply a machine learning model to the merchant data and issuer data to generate a prediction as to whether the transaction was fraudulent,
provide a report to the user comprising one or more factors on which the prediction is based, the one or more factors based on at least one of the merchant data and the issuer data,
receive feedback relating to the prediction, and
update the machine learning model using the feedback as an input.

11. The system of claim 10, wherein the processor is further configured to receive mobile device data for a mobile device associated with the user.

12. The system of claim 11, wherein the mobile device data comprises a plurality of an internet protocol address, a geo-location, and a unique device identifier (ID).

13. The system of claim 11, wherein the merchant data includes the mobile device data.

14. The system of claim 10, wherein the merchant data comprises a plurality of a user name, a user phone number, a user email address, a user physical address, a list of historical merchant transactions, a frequency of merchant purchases, an account age for a merchant account associated with the user, a total number of items, recurring order information, shipping information, and a merchant risk score.

15. The system of claim 10, wherein the user-based allegation of a fraudulent transaction is approved or denied based on the prediction as to whether the transaction was fraudulent.

16. The system of claim 10, wherein the processor is further configured to provide an option for the user to retract the user-based allegation of a fraudulent transaction.

17. The system of claim 16, wherein the feedback on the prediction comprises a user response to the option for the user to retract the user-based allegation of a fraudulent transaction.

18. The system of claim 10, wherein the processor is further configured to receive, via a communication hub, supplemental user data from a plurality of issuers or a plurality of banks.

19. The system of claim 18, wherein the processor is further configured to send the prediction as to whether the transaction was fraudulent to the communication hub.

20. A computer-readable non-transitory medium comprising computer-executable instructions that, when executed by a processor, cause the processor to perform procedures comprising the steps of:
receiving a user-based allegation of a fraudulent transaction;
receiving merchant data pertaining to a user associated with the user-based allegation as well as a transaction underlying the user-based allegation;
receiving issuer data pertaining to the user and the transaction;
applying a machine learning model to the merchant data and issuer data to generate a prediction as to whether the transaction was fraudulent;
providing a report to the user comprising one or more factors on which the prediction is based, the one or more factors based on at least one of the merchant data and the issuer data;
receiving feedback relating to the prediction; and
updating the machine learning model using the feedback as an input.
